(19) United States
(12) Patent Application Publication
(10) Pub. No.: US 2013/0153386 A1
(43) Pub. Date: Jun. 20, 2013

(54) ELECTRONIC DEVICE WITH KEYPAD ASSEMBLY

(71) Applicant: GUO-DONG LI, Shenzhen City (CN)

(72) Inventor: GUO-DONG LI, Shenzhen City (CN)

(21) Appl. No.: 13/653,111

(22) Filed: Oct. 16, 2012

(30) Foreign Application Priority Data
Dec. 17, 2011 (CN) 201110423655.6

(51) Int. Cl. H01H 13/76

(52) U.S. Cl. 200/5 A

(57) ABSTRACT

A keypad assembly is attached to a housing of an electronic device. The housing defines a plurality of key holes, the keypad assembly including an elastic sheet and a number of key caps. The elastic sheet includes a number of key bodies and a number of contacts formed at opposite surfaces thereof. The elastic sheet is positioned at a first side of the housing, and the key bodies extend through the key holes. The key caps are positioned at a second side of the housing, and are mounted on the key bodies.

### BACKGROUND

1. Technical Field

The present disclosure generally relates to keypad assemblies, particularly to a keypad assembly to be used for electronic devices.

2. Description of related art

A typical keypad assembly is usually assembled to a front housing of an electronic device. The typical keypad assembly includes a keypad, a frame and a shielding element. The frame is used for supporting the keypad, and the shielding element is used for preventing light under the keypad from leaking from the keypad. However, due to need for the frame and the shielding element, the typical keypad assembly is unduly bulky. Additionally, the frame and the shielding element also occupy the inside space of the electronic device.

Therefore, there is room for improvement within the art.

### BRIEF DESCRIPTION OF THE DRAWINGS

Many aspects of the disclosed keypad assembly can be better understood with reference to the following drawings. The components in the drawings are not necessarily drawn to scale, the emphasis instead being placed upon clearly illustrating the principles of the present keypad assembly.

FIG. 1 is an exploded view of a keypad assembly for electronic devices in accordance with an exemplary embodiment.

FIG. 2 is similar to FIG. 1, but shown from another aspect.

FIG. 3 is an assembled view of the keypad assembly of FIG. 1.

FIG. 4 is a cross sectional view of the keypad assembly taken along line IV-IV in FIG. 3.

### DETAILED DESCRIPTION

The disclosed keypad assembly may be applied in portable electronic devices such as mobile phones or personal digital assistants (PDA) in accordance with an exemplary embodiment. In the exemplary embodiment, the keypad assembly being used in a mobile phone is illustrated, although the disclosure is not limited thereto.

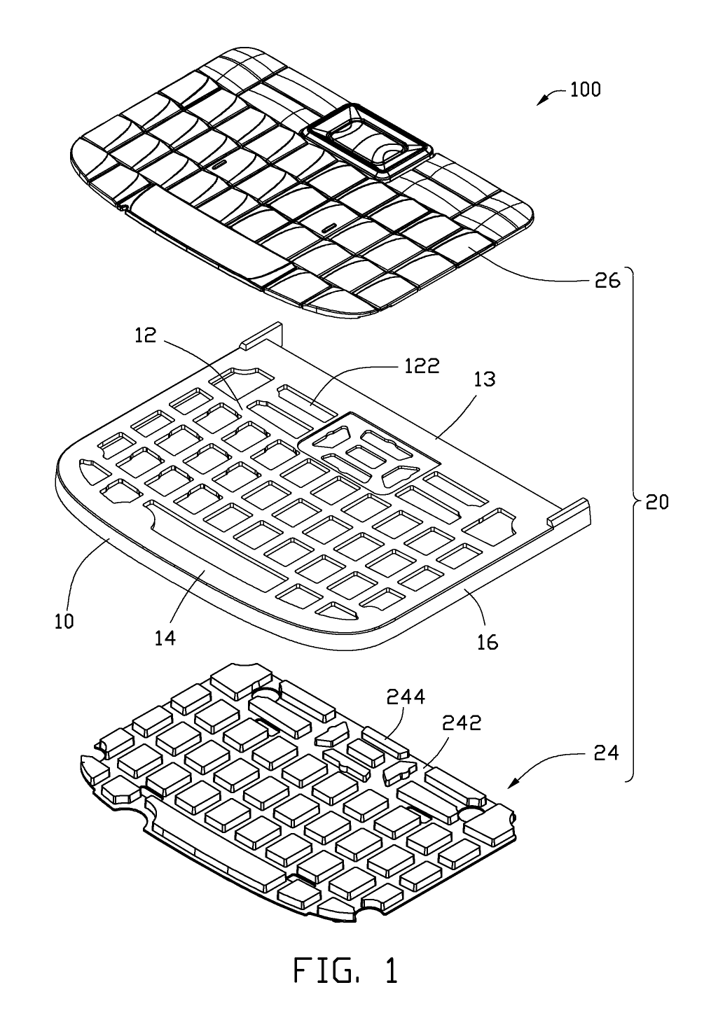

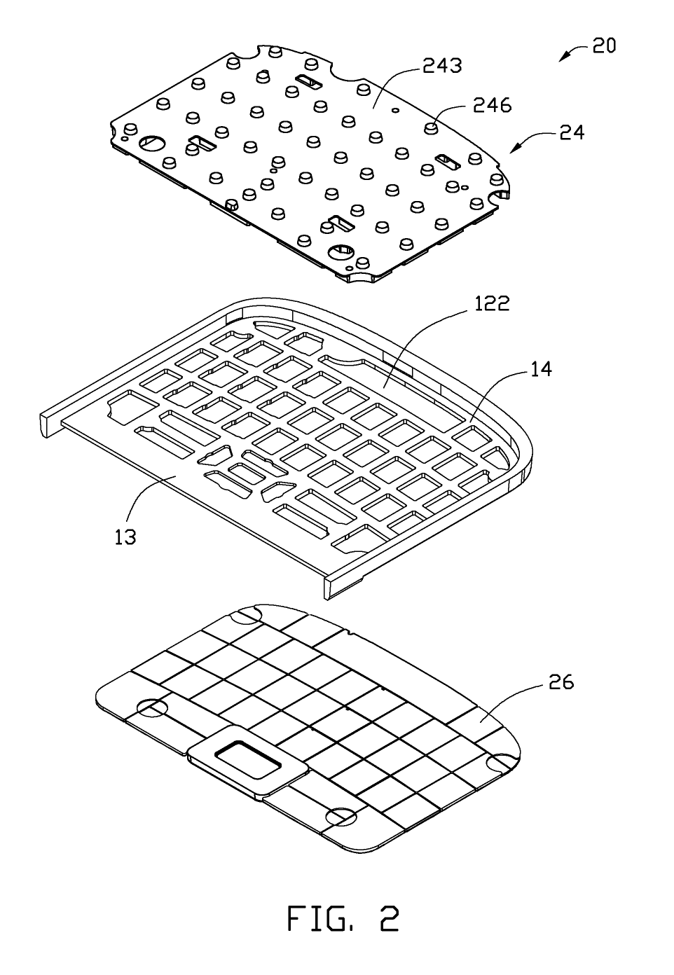

Referring to FIGS. 1 and 2, an exemplary embodiment of one part of an electronic device 100 is shown. The electronic device 100 includes a housing 10 and a keypad assembly 20.

The housing 10 can be a portion of the electronic device, or be separately formed and then assembled to the electronic device 100. The keypad assembly 20 is directly mounted to the housing 10. The housing 10 is made of opaque material, and includes a main plate 12, a first end 13, a second end 14 and two side portions 16. The main plate 12 is substantially a flat plate, and defines a plurality of key holes 122. The second end 14 and the two side portions 16 are substantially coplanar with the main plate 12.

The keypad assembly 20 includes an elastic sheet 24 and a number of key caps 26.

The elastic sheet 24 is directly attached to one side of the housing 10. The elastic sheet 24 includes a first surface 242 and a second surface 244 opposite to the first surface 243. A plurality of key bodies 244 are formed on the first surface 242, and a plurality of contacts 246 are formed on the second surface 243. The key bodies 244 protrude from the key holes 122 of the housing 10. The contacts 246 are arranged corresponding to the key bodies 244. In this exemplary embodiment, the elastic sheet 24 is made of rubber. When the key bodies 244 are pressed, the contacts 246 deform and contact a printed circuit board in the electronic device 100 to trigger an input signal.

The key caps 26 are directly attached to another side of the housing 10. Since the second end 14 and the side portions 16 are coplanar with the main plate 12, the key caps 26 can extend to the brim of the housing 10 to be respectively coplanar with the second end 14 and the side portions 16. The key caps 26 are made of plastic, and are respectively mounted on the key bodies 244 exposed from the key holes 122 of the housing 10 for pressing the key bodies 244. In this exemplary embodiment, the key caps 26 are adhered on the key bodies 244 with ultraviolet glue.

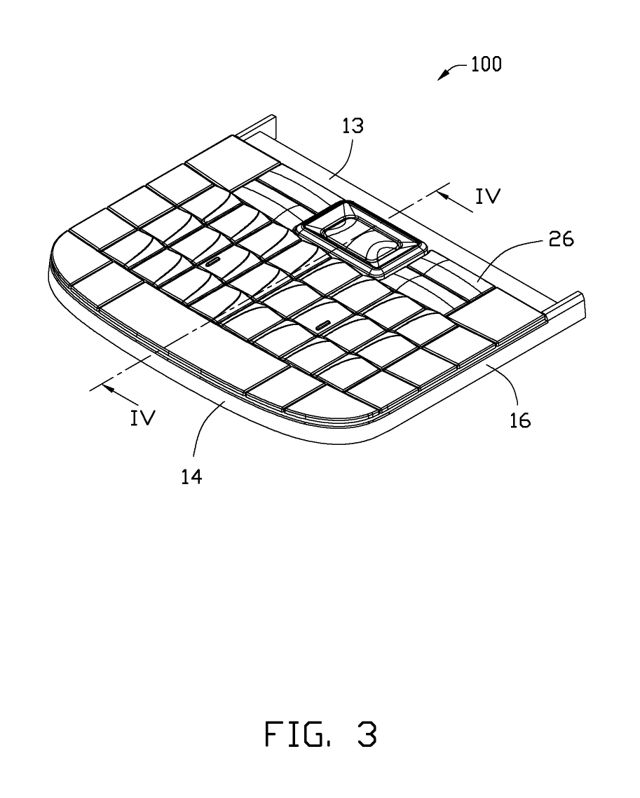

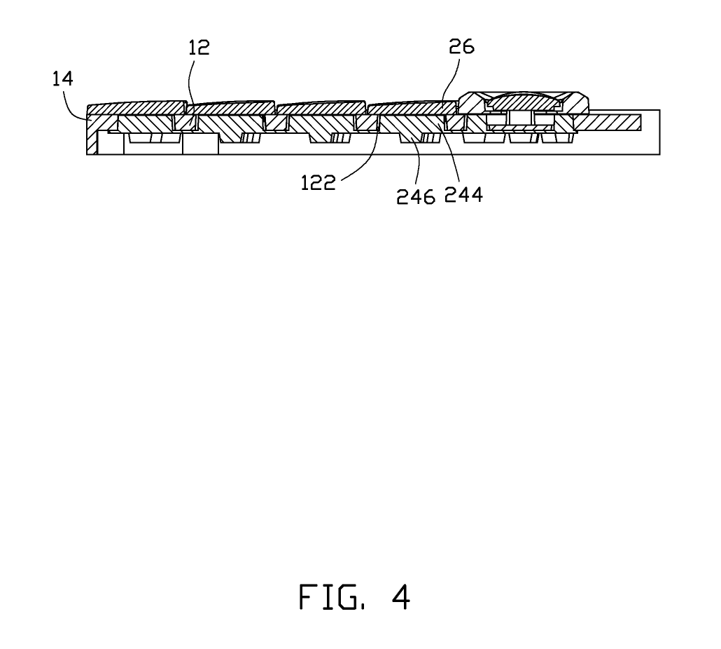

Referring to FIGS. 3 and 4, the keypad assembly 20 can be but is not limited to be assembled in the following steps.

The elastic sheet 24 is positioned under the housing 10, and the key bodies 244 extend through the key holes 122 of the housing 10. Then, the key caps 26 are adhered to the key bodies 244. Accordingly, the housing 10 is sandwiched between the key caps 26 and the elastic sheet 26. Thus, the assembled process is finished. The housing 10 may directly support the key caps 26. Since the housing 10 is made of opaque material, the housing 10 can effectively prevent light from leaking therefrom.

The present keypad assembly does not need to an extra frame and a shielding element. Thus, the structure of the keypad assembly is very simple. Additionally, the key caps 26 can be disposed to the side portions 16 and the second end 16 of the housing 10. Thus, the size of the keypad is increased for conveniently operation.

It is to be understood, however, that even through numerous characteristics and advantages of the present disclosure have been set forth in the foregoing description, together with details of assembly and function, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A keypad assembly attached to a housing of an electronic device, the housing defining a plurality of key holes, the keypad assembly comprising:
an elastic sheet directly positioned at a first side of the housing, the housing including a plurality of key bodies and a plurality of contacts formed at opposite surfaces thereof, the key bodies extending through the key holes; and
a plurality of key caps directly positioned at a second side of the housing, and mounted on the key bodies.

2. The keypad assembly as claimed in claim 1, wherein the housing is made of opaque material, and includes a main plate, a first end, a second end and two side portions, the main plate is substantially a flat plate, the second end and the two side portions are substantially coplanar with the main plate, the key caps are coplanar with the second end and the side portions.

3. The keypad assembly as claimed in claim 2, wherein the key caps are made of plastic, and the elastic sheet is made of rubber.

4. The keypad assembly as claimed in claim 1, wherein the key caps are adhered on the key bodies with ultraviolet glue.

5. An electronic device comprising:
a housing defining a plurality of key holes;
a keypad assembly comprising:
an elastic sheet including a plurality of key bodies and a plurality of contacts formed at opposite surfaces thereof, the elastic sheet positioned at a first side of the housing, the key bodies extending through the key holes; and
a plurality of key caps positioned at a second side of the housing, and mounted on the key bodies.

6. The electronic device as claimed in claim 5, wherein the housing is made of opaque material, and includes a main plate, a first end, a second end and two side portions, the main plate is substantially a flat plate, the second end and the two side portions are substantially coplanar with the main plate, the key caps are coplanar with the second end and the side portions.

7. The electronic device as claimed in claim 6, wherein the key caps are made of plastic, and the elastic sheet is made of rubber.
